(19) United States
(12) Patent Application Publication
(10) Pub. No.: US 2023/0027204 A1
(43) Pub. Date: Jan. 26, 2023

(54) PRODUCT SUPPORT SYSTEM THAT FACILITATES CUSTOMER ISSUE PRIORITIZATION VIA AUTOMATED NEAR REAL-TIME INGESTION, ENRICHMENT, AND PRESENTATION OF CUSTOMER SUPPORT DATA

(71) Applicant: Intel Corporation, Santa Clara, CA (US)

(72) Inventors: Tarek Abdel-Radi, Covington, WA (US); Kelley Mullick, Hillsboro, OR (US); Lee Hoang, Portland, OR (US); Matthew DeGeer, Tillamook, OR (US)

(73) Assignee: Intel Corporation, Santa Clara, CA (US)

(21) Appl. No.: 17/945,734

(22) Filed: Sep. 15, 2022

(51) Int. Cl. G06Q 30/00; G06Q 30/02; G06Q 10/06

(52) U.S. Cl. CPC G06Q 30/016; G06Q 30/0201; G06Q 10/06393

(57) ABSTRACT

Embodiments described herein are generally directed to an improved product support system. In an example, one or more computer systems of a product support system, capture data relating to product support cases including one or more levels of support data from multiple data sources in accordance with a predefined or configurable schedule. Access to historical versions of a set of metrics for the data by or on behalf of one or more product support personnel is enabled by creating and persisting time-series data in near real-time based on periodic snapshots of the product support cases including counts of the product support cases associated with one or more categories.

### TECHNICAL FIELD

Embodiments described herein generally relate to the field of product support services and customer feedback analytics and, more particularly, to a product support system architecture that facilitates customer issue prioritization, the ability to scale the support team and supported products, and interactive visualization of metrics and associated patterns, trends, and/or target thresholds via automated near real-time ingestion, enrichment, and presentation of customer support data received from potentially multiple data sources with time-series data.

### BACKGROUND

The provision of efficient and high-quality product support (also referred to as technical support or “tech support”) by or on behalf of an organization that sells products or services improves customer loyalty and increases the likelihood of customers purchasing additional products or services offered by the organization. Often product support is done via knowledge bases, live chat, email, and/or phone and with the goal of solving technical problems, errors, and/or other difficulties faced by customers.

There are various levels of product support, including pre-support, self-service, level-1 (L1) support (or first line support), level-2 (L2) support (or second line support), and level-3 (L3) support (or third line support). Pre-support typically involves customers making use of search engines and/or otherwise scouring the web for answers to their questions. The next level in tech support, self-service, involves allowing users to self-serve and is typically managed through self-help wikis, frequently asked questions (FAQs), knowledge bases and in some cases recommendations made by the system either reactively or proactively or both. While, many of the most common customer questions may be resolved through a self-service level, FAQs and knowledge bases cannot address every issue that may arise. As such, at times users will want to speak to or otherwise interact with a human (which may be referred to herein as a product support engineer, a tech support engineer, or simply a support engineer) via email, phone or live chat support. Organizations may offer first line support via support personnel having a basic to general understanding of the product or service. Support personnel at this level may not always have the competency required or bandwidth for solving complex issues. Generally, the goal for this level of support is to handle 70-80% of user problems before such issues are escalated to a higher level.

Support cases that are escalated to the second line of support generally involve more complex issues. This level of support is typically provided by staff with in-depth knowledge of the product that are able to provide technical guidance for more complicated situations. Supported cases that remain unresolved and require even more expertise are escalated to the third line of support. L3 support deals with outlier cases that the prior levels (e.g., pre-support to second line) were unable to handle. By the time a user issue gets to this level of support, it likely involves customer work to solve it. Third line tech support may be managed by a designated super user or potentially even someone from the organization's research and development department.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a context level diagram illustrating external actors that may interact with a product support system according to some embodiments.

FIG. 2 is a block diagram illustrating an example of a backend processing component of a product support system according to some embodiments.

FIG. 3 is a block diagram illustrating an example of a correlation and visualization component of a product support system according to some embodiments.

FIG. 4 is a flow diagram illustrating operations for performing automated time-series data injection and snapshot generation according to some embodiments.

FIG. 5 is a flow diagram illustrating operations for performing automated alert generation according to some embodiments.

FIG. 6 is a flow diagram illustrating operations for generation of dashboard charts according to some embodiments.

FIG. 7 is an entity relationship diagram illustrating an example data model according to some embodiments.

FIG. 8 is a screen shot illustrating an example visualization of support cases, key performance indicators (KPIs), and customer feedback to facilitate consumption and interaction by product support management personnel according to some embodiments.

FIG. 9 is a screen shot illustrating an example visualization that may be used for day-to-day triaging of support cases according to some embodiments.

FIG. 10 is a screen shot illustrating an example MTTR trend chart according to some embodiments.

FIG. 11 is a screen shot illustrating an example NPS trend chart according to some embodiments.

FIG. 12 is an example of a computer system with which some embodiments may be utilized.

### DETAILED DESCRIPTION

Embodiments described herein are generally directed to an improved product support system. A number of existing product support tools and procedures attempt to facilitate customer communications and track support cases through the various levels. Product support solutions currently employed by organizations may include the review of lengthy configuration guides, technical product specifications (TPS), past similar support cases, service guides and Software Deployment Playbooks to help narrow down issues. Support team members often rely on specialized knowledge in limited areas and are not provided with opportunities for cross-pollination. Product support teams may rely on performing best-effort root cause analysis (RCA) of support cases which may result in a large mean time to resolution (MTTR).

Existing product support tools and procedures have numerous disadvantages and limitations, including the inability to facilitate the identification of customer pain points and trends promptly, consistently, or quantitatively. As a result, product support teams may operate in a reactive and very manual mode, potentially overlooking cases that need prompt attention. For example, obtaining access to historical versions of desired metrics relating to support data is presently a very time-consuming and manual task involving sorting of the data.

Additional disadvantages and limitations of various existing product support tools and procedures include (i) non-scalable issue resolutions due to the reactive nature of the process, the need for manual intervention, and the inability to leverage the findings of similar issues that may already have been resolved by other support engineers; (ii) customer feedback that is inconsistently acted upon; (iii) the lack of quantitative measures of the quality of service delivered to customers; (iv) the requirement for support engineers to execute manual queries to identify customer issues in need of resolution; (v) lack of mechanisms to prioritize workflow among the support team, thereby resulting in ad hoc approaches, including team members running different queries and considering different factors, thereby arriving at differing conclusions regarding relative priorities of support cases; (vi) the inability to identify patterns and trends without manual and cumbersome steps; and (vii) the manual filtering of issues by domain, customer, and/or issue type and resulting inconsistent results.

Various embodiments of the present technology provide for a wide range of technical effects, advantages, and/or improvements to computing systems and components. For example, various embodiments may include one or more of the following technical effects, advantages, and/or improvements: (i) near real-time ingestion by a product support system of data relating to support cases from multiple data sources, for example, via scripting and/or backend processing executed regularly with zero touch; (ii) near real-time enrichment of the data via automated correlation of time-series data with support case records to facilitate visualization of data, indicators, trends, and targets graphically and statistically while also providing interactive selection/deselection of items of interest in real-time as well as filtering by manager, owner, product, issue type, and the like; (iii) automated alerting of support engineers regarding prioritization of support cases, for example, based on analysis and identification of support cases meeting certain criterion (e.g., support cases that have not been updated within a particular timeframe and owned by a particular support engineer, or support cases that have been active for more than a specific duration and owned by a particular support engineer).

Individually and collectively the aforementioned features improve the operation, scalability, efficiency, and effectiveness of a product support system. In various embodiments described herein, a backend processing component of a product support system captures and ingests in near real-time data relating to support cases that include one or more levels of product/service support data (e.g., support data regarding an information technology (IT) product/service) from multiple data sources (e.g., real-time mission-critical data sources, such as third-party systems and/or databases, utilized by the product support personnel, such as support engineers) in accordance with a predefined or configurable schedule. The backend processing component may further facilitate access to historical versions of a set of metrics for the data by or on behalf of one or more product support personnel via a frontend processing component of the product support system by creating and persisting time-series data based on periodic snapshots of the support cases including counts of the of support cases associated with one or more categories (e.g., active support cases, not-updated support cases, and aged support cases).

As described further below, in some embodiments, the product support system ingests large amounts of data from differing sources, parses and analyses that data, then sends automated alerts to support engineers (and other interested parties such as their manager) when the system determines action should be taken on particular customer issues.

In some embodiments, user experience (UX) is enhanced through the ability to visualize data regarding the support cases along with indicators, trends, and targets, updated in near real-time that may be presented graphically and statistically and through a user interface (UI) that facilitates interactive selection/deselection of items of interest and filtering capabilities that can be performed in real time. For example, Pareto charts of top issues may be presented to product support management personnel. Such charts may further enable data slicing to facilitate drilldown investigations, issue prioritization as well as pattern and trend identification. This ability to dissect the data per the user's needs can quickly help them identify and address potential customer concerns.

While various examples described herein may be described with reference to specific products (e.g., server systems), the methodologies described herein are generally applicable to other types of products or services.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, the phrase “near real-time” relates to a system or process in which input data is generally processed slower than real-time but within about 60 minutes.

As used herein, the phrase “aged support case” generally refers to an active support case that has been open (unresolved) for more than a particular amount of time (e.g., 90 days).

As used herein, the phrase “not-updated support case” generally refers to an active support case for which no associated comments have been received or entered by the owner or author (e.g., the responsible product support engineer) of the support case or by the customer for a particular amount of time (e.g., 14 days). Other implementations may consider a case as “not-updated” if any of its fields were unmodified during a particular amount of time.

The terms “component”, “module”, “system,” and the like as used herein are intended to refer to a computer-related entity, either a software-executing general purpose processor, hardware, firmware, or a combination thereof. For example, a component may be, but is not limited to being, a process running on a processor, an object, an executable, a thread of execution, a program, and/or a computer.

### Example Product Support System

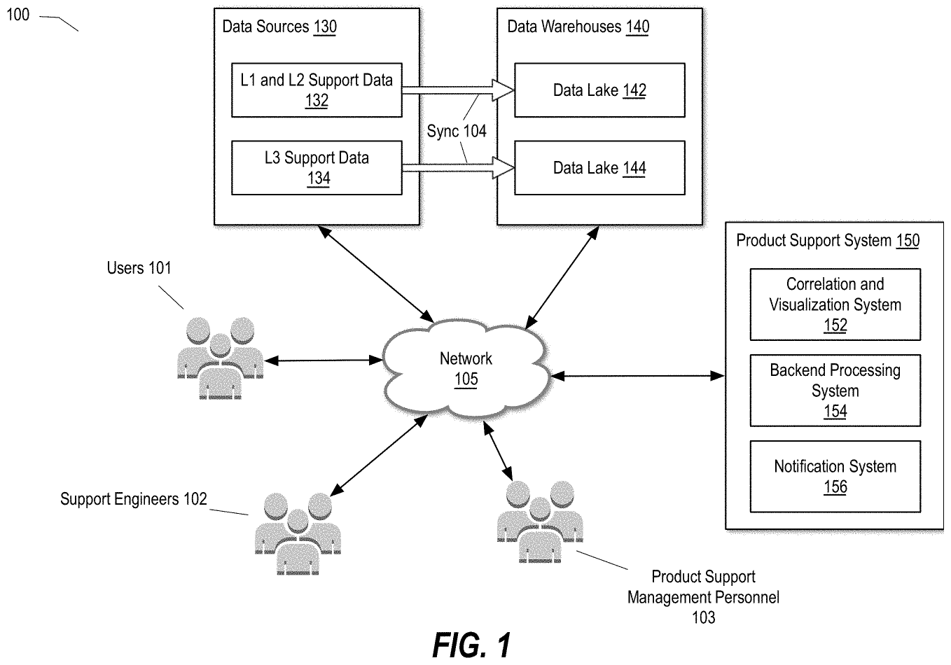

FIG. 1 is a context level diagram illustrating external actors that may interact with a product support system 150 according to some embodiments. In the context of the present example, customers (e.g., users 101) of a product or service vendor may interact with members of a support team of product support personnel (e.g., support engineers 102 employed by the vendor and/or working on a contract basis), for example, via a public network 105 (e.g., the Internet) via phone, chat or electronic mail (email) to obtain assistance in resolving an issue they may be experiencing with the product or service.

The product support personnel may create and modify support case records and/or associated records (e.g., containing comments input by customers and/or the product support personnel) within data sources 130 or elsewhere as they handle customer inquiries. The data sources 130 may represent a case table containing information about each product support case. For example, a support case record may be created with a unique identifier (ID), an indication of the “owner” (e.g., a particular product support engineer that is assigned to work on the case), information identifying the product/service at issue, a description of the problem or issue being experienced by the customer (or user), a case type, among other information, within L1 and L2 support data 132 responsive to an initial customer contact. Support cases that are not resolved at L1 or L2 may be assigned new support case records when they are escalated to L3 and stored within L3 support data 134. The data sources 130 may represent geographically distributed data this is used by and/or populated by real-time mission-critical systems and may be managed by third parties, such as Salesforce, SAP, ServiceNow, and the like. For example, based on the data sources 130, related support cases and collateral may be automatically identified and presented to support engineers 102 using artificial intelligence tools (not shown) or as a result of queries submitted by the support engineers 102.

In the context of the present example, data sources 130 may be periodically synchronized (e.g., sync 104) with data warehouses 140 in accordance with a predetermined or configurable schedule (e.g., every 5 to 12 hours). For example, L1 and L2 support data 132 may be periodically replicated at 8-hour intervals to a corresponding data lake 142 and L3 support data 134 may be periodically replicated at 8-hour intervals to a corresponding data lake 144. These data lakes 142 and 144 may represent large datasets ranging in size from gigabytes to petabytes of data stored and processed by a “Big Data” framework (e.g., Apache Hadoop) and accessible to the product support system 150 via query (e.g. structured query language, SQL) operations. Such tiering of data may serve multiple purposes. For example, limiting access to support case data by the product support system 150 to that contained within the data warehouses 140 insulates the data sources 130 from searching, querying, and/or retrieval operations that may be performed by various components of the product support system 150, thereby avoiding impacting the performance and availability of mission-critical tasks. Downtime of the product support system 150 may also be avoided as a result of having access to an effectively redundant dataset. As those skilled in the art will appreciate, it may be desirable to make use of tightly controlled access privileges or some other mechanism to manage if and how users 101 would have direct access to the data sources 130 and the data warehouses 140.

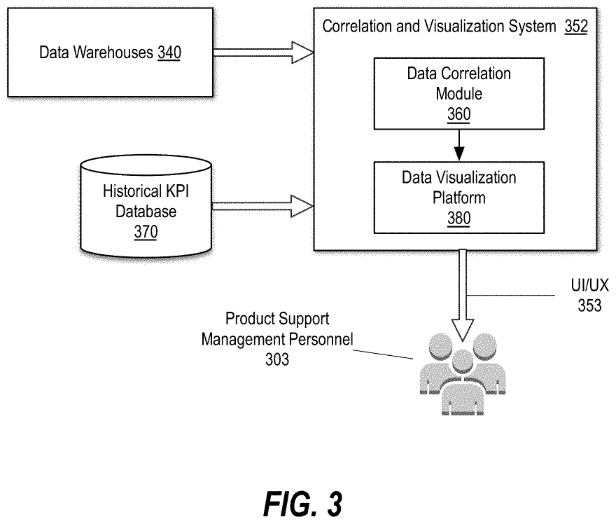

Turning now to the product support system 150, it is shown including a correlation and visualization system 152, a backend processing system 154, and a notification system 156. The correlation and visualization system 152 may be responsible for correlating data from a number of different datasets and providing UI/UX visualization of various slices and/or subsets of the data of interest to product support management personnel 103. A non-limiting example of the correlation and visualization system 152 is described further below with reference to FIG. 3.

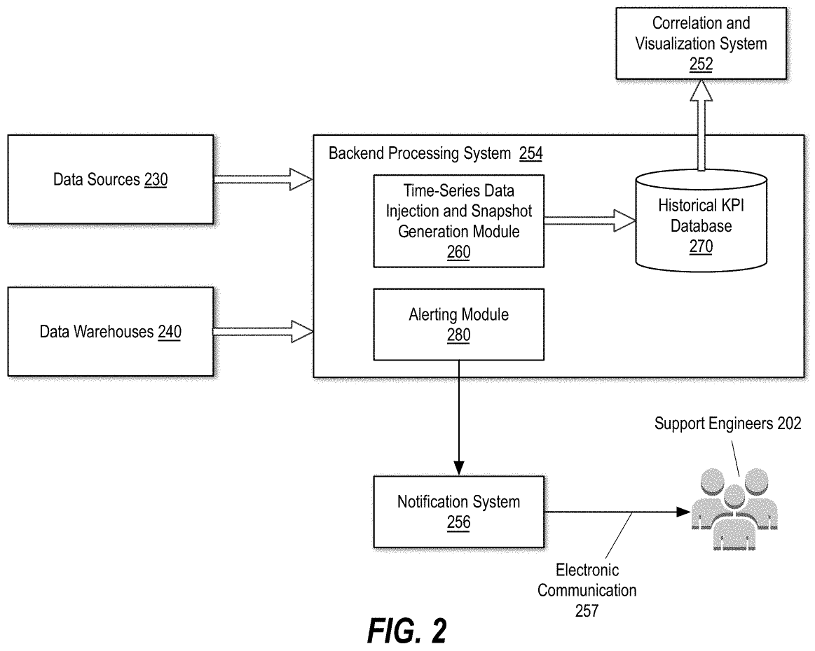

The backend processing system 154 may include one or more computer systems and be responsible for running various automations (e.g., scripts) at potentially different cadences, including a first set of one or more alerting scripts that implement algorithms for sending automated reminders and/or notifications via the notification system 156 (e.g., an electronic communication mechanism, such as email, short message system (SMS), or other messaging programs or team chat tools, such as Slack, Microsoft Teams, or the like) to members of the support team based on various metrics and a second script with algorithms that build time-series data for the various metrics. A non-limiting example of the backend processing system 154 is described further below with reference to FIG. 2.

In order to facilitate efficient processing, triaging and/or prioritization of customer issues, a number of features are provided by the product support system 150 that are described in further detail below, including the ability to ingest large amounts of support case data in near real-time (e.g., within about an hour) from multiple data sources, parse the data, and translate it into various metrics, some of which may represent key performance indicators (KPIs) (e.g., Net Promotor Score (NPS), Reasonable Time (RT), Customer Effort (CE), Time-to-Response (TTR), Mean Time To Resolution (MTTR), Helpful Info Score, Issue Resolved Score, Overall Satisfaction Score, and the like. Additional metrics may include counts and targets of support cases associated with various categories (e.g., active support cases, not-updated support cases, and aged support cases).

Several metrics of value are historical in nature and may not be capable of being generated from the current data instance as stored in the data sources 130 or the data warehouses 140. In one embodiment, a time-machine like feature enables members of the support team to identify these metrics over time. For example, as described in more detail below, a data correlation feature of some embodiments facilitates the automatic generation of time-series data that may be correlated together programmatically with support case data, thereby enriching the data with additional useful information. The results of the correlation may be presented to members of the support and management teams through a UI/UX available through the correlation and visualization system 152 that allows the selection of items and attributes of interest in real-time and drilling down through the data in a consistent and intuitive way.

Another feature of various embodiments includes the ability of the product support system 150 to send automated electronic communications (e.g., alerts) to support engineers 102 when the product support system 150 determines action should be taken on a customer issue. In this manner, support engineers 102 may be provided with information to help them prioritize the order in which they handle support cases.

In various embodiments, scripting and backend processing dynamically capture data in near real-time and is executed regularly with zero touch. As noted above, due to the nature of the data, historical calculations may not be available in retrospect, thus automation may be provided to generate desired time-series data that can be accessed as needed. In addition, when KPIs exceed predefined thresholds (or targets), automation may be implemented so as to automatically notify support case owners

In some embodiments, the UI/UX visualization of the data as supported by the correlation and visualization system 152, which may include one or more computer systems dedicated to frontend processing, includes displaying indicators, trends, and targets, for example, via a browser-based interface on a display device of a client computer system utilized by a member of the product support team. The indicators, trends, and targets may be presented graphically and statistically and may support interactive selection/deselection of items of interest that can be edited to cause the UI/UIX visualizations to be updated in real-time.

### Example Backend Processing Component

FIG. 2 is a block diagram illustrating an example of a backend processing component (e.g., backend processing system 254, which may be analogous to backend processing system 154) a product support system (e.g., product support system 150) according to some embodiments. In one embodiment, the backend processing component includes one or more computer systems (not shown) logically interposed between data sources 230 (which may be analogous to data sources 130) and data warehouses 240 (which may be analogous to data warehouses 140) and correlation and visualization system 252 (which may be analogous to correlation and visualization system 152).

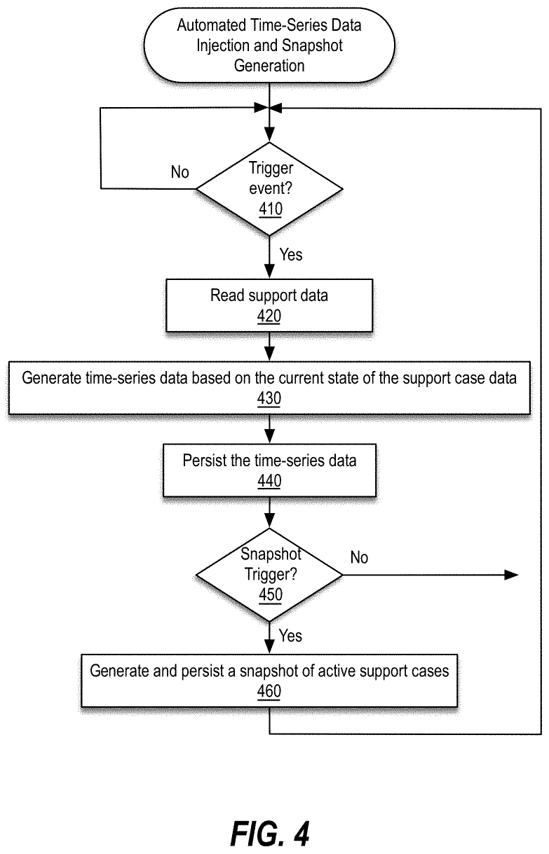

In the context of the present example, backend processing system 254 is shown including a time-series data injection and snapshot generation module 260 an alerting module 280, and a historical KPI database 270. As noted above, there may be useful metrics that are historical in nature that may not be capable of being generated from the current data instance as stored in the data sources 230 or the data warehouses 240. In one embodiment, a time-machine like feature implemented by the time-series data injection and snapshot generation module 260 may be responsible for periodically creating time-series data based on the current state of the support case records as of the time/date of creation of such time-series data. For example, the time-series data injection and snapshot generation module 260 may include multiple scripts implementing, among other things, algorithms that build time-series data for various metrics (e.g., active support case counts, aging support case counts, not-updated support case counts, NPS, RT, CE, MTTR, Helpful Info Score, Issue Resolved Score, Overall Satisfaction Score, and/or the like) by product/service and/or for one or more of various time periods (e.g., a work week, a month, or a quarter) based on periodic snapshots of the support case records pulled from the data sources 230 and/or the data warehouses 240. A non-limiting example of automated time-series data injection and snapshot generation processing that may be performed by the time-series data injection and snapshot generation module 260 is described further below with reference to FIG. 4.

The resulting time-series data and snapshots of the various metrics generated by the time-series data and snapshot generation module 260 may be persisted, for example, to the historical KPI database 270 for subsequent use by the correlation and visualization system 252. While in the present example, the historical KPI database 270 is shown as residing internal to the backend processing system 254, it may alternatively reside external to the backend processing system 254. In one embodiment, the historical KPI database 270 is in the form of a SQL database to facilitate querying and data correlation performed by the correlation and visualization system 252.

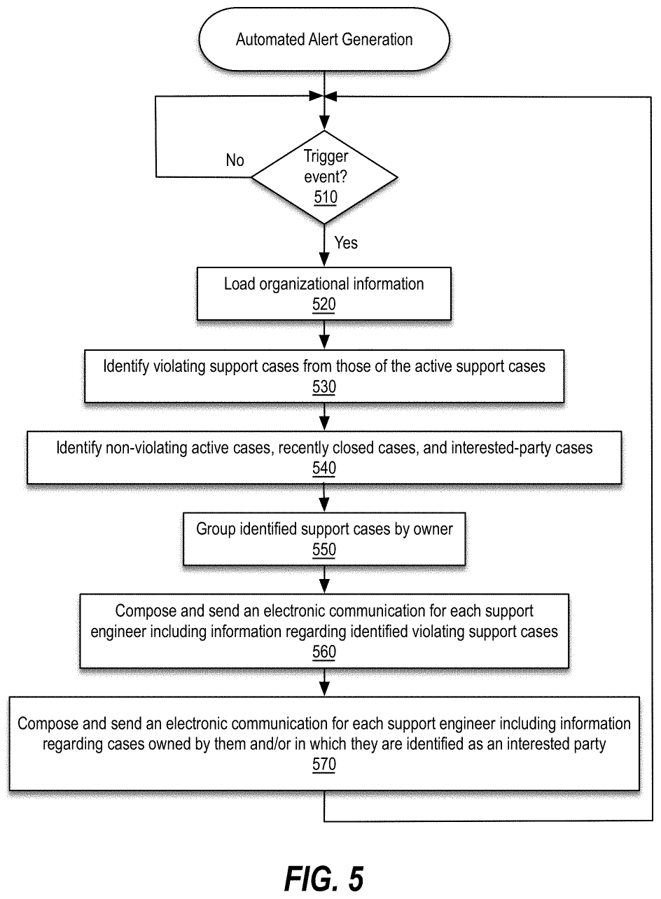

In one embodiment, the alerting module 280 may include one or more scripts implementing algorithms that send automated reminders and/or notifications to members of a product support team (e.g., support engineers 202, which may be analogous to support engineers 102). For example, as the backend processing system 254 ingests large amounts of data from differing sources (e.g., the data sources 230 and/or the data warehouses 240) and parses and analyses that data, the alerting module 280 may be responsible for automatically generating alerts that are to be sent to the support engineers via notification system 256 (which may be analogous to notification system 156). Depending upon the particular implementation members of the support team may be alerted regarding support cases determined to satisfy certain criterion (e.g., support cases that have not been updated within a particular timeframe and owned by a particular support engineer). In this manner, the alerting module 280 may facilitate prioritization of handling of active support cases by respective owners of the support cases, thereby improving the product support services provided to customers of the vendor at issue. A non-limiting example of automated alert generation processing that may be performed by the alerting module 280 is described further below with reference to FIG. 5.

### Example Frontend Processing Component

FIG. 3 is a block diagram illustrating an example of a correlation and visualization component 352 (an example of a frontend processing component that may be analogous to correlation and visualization system 152) of a product support system (e.g., product support system 150) according to some embodiments. In one embodiment, the correlation and visualization system 352 includes one or more computer systems (not shown) logically interposed between data warehouses 340 (which may be analogous to data warehouses 140) and historical KPI database 370 (which may be analogous to historical KPI database 270) and product support management personnel 303 (which may be analogous to product support management personnel 103).

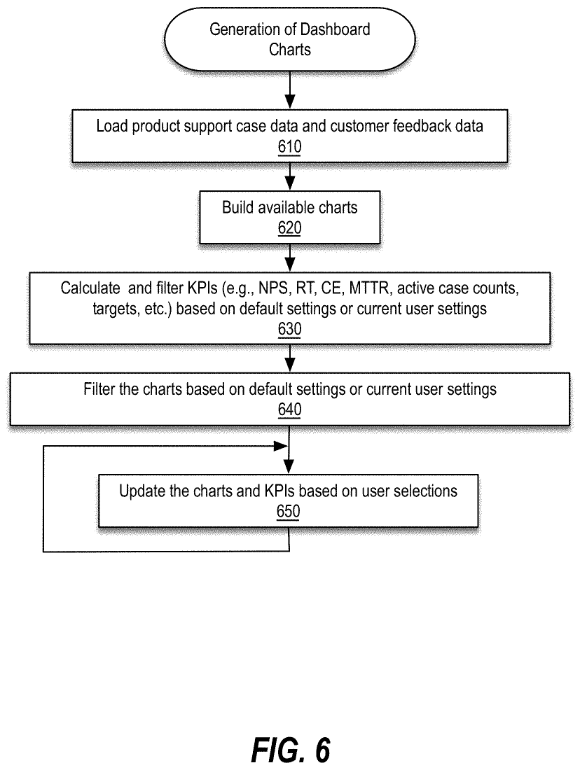

In the context of the present example, correlation and visualization system 352 is shown including a data correlation module 360 and a data visualization platform. In one embodiment, the data correlation module 360 is responsible for programmatically correlating together the time-series data persisted to the historical KPI database 370 with support case records stored within the data warehouses 340, thereby enriching the support case data with additional information that may be useful to the product support management personnel 303, for example, in connection with managing the efficient resolution of support cases. For its part, the data visualization platform 380 may be responsible for graphically and statistically presenting the various indicators, trends, thresholds, and targets made available via the data correlation module 360 via a UI/UX, for example, in the form of charts presented on a dashboard that supports interactive filtering, (e.g., selection/deselection of items of interest) in real-time and drilling down through the data in a consistent and intuitive way. A non-limiting example of the data visualization platform 380 is a commercial business intelligence (BI) tool, such as Microsoft Power BI. A non-limiting example of generation of dashboard charts that may be performed by the data visualization platform 380 is described below with reference to FIG. 6.

As will be understood based on the architecture of the product support system as described and illustrated with respect to FIGS. 1-3, data may be processed by the product support system at multiple levels (e.g., the synchronization from data sources 130 to data warehouses 140, the periodic generation and injection of time-series data by the time-series data injection and snapshot generation module 260, the data correlation performed by the data correlation module 360, and the updating of visualizations performed by the data visualization platform 380). The rate at which data is processed at these various levels may be configurable, for example, the interval at which data is synchronized and the time between inj ection of new time-series data. As described further below, various automations (e.g., in the form of scripts) may be performed in near real-time as part of the generation and injections of time-series data, whereas updates to UI/UX visualizations presented based on and/or including such time-series data may be performed in real-time responsive to user interactions (e.g., the establishment of more coarse or more fine data slices, the selection/deselection of types, categories, and/or subsets of support cases via setting of user-defined filters).

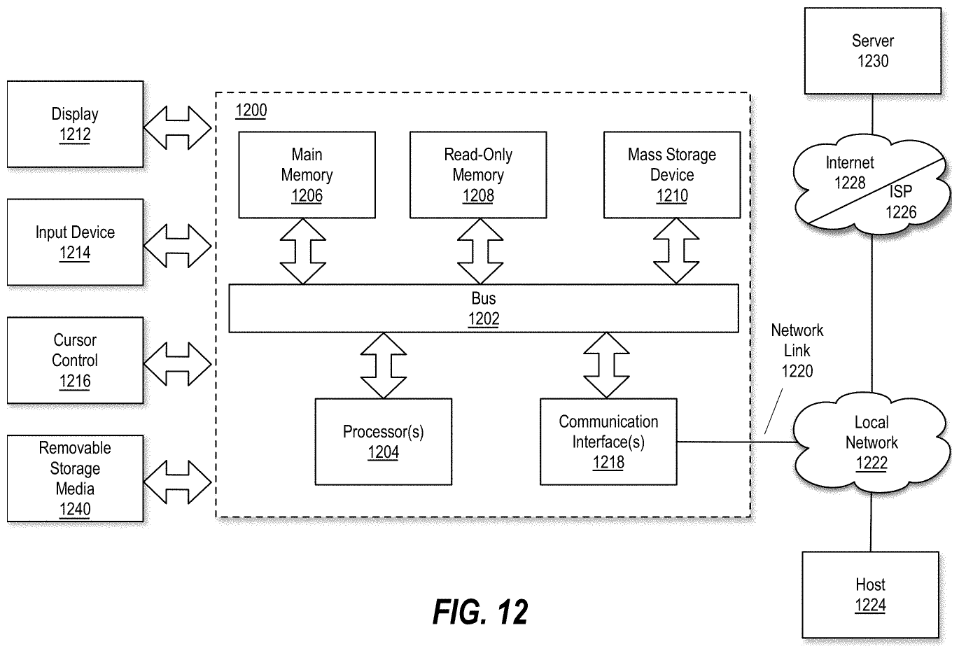

The various modules of FIGS. 1-3 and the processing described below with reference to the flow diagrams of FIGS. 4-6 may be implemented in the form of executable instructions stored on a machine readable medium and executed by a processing resource (e.g., a microcontroller, a microprocessor, a CPU core, an ASIC, an FPGA, or the like) and/or in the form of other types of electronic circuitry. For example, the processing may be performed by one or more virtual or physical computer systems of various forms, such as the computer system described below with reference to FIG. 12.

### Example Automated Time-Series Data Injection and Snapshot Generation

FIG. 4 is a flow diagram illustrating operations for performing automated time-series data injection and snapshot generation according to some embodiments. The processing described with reference to FIG. 4 may be performed by one or more scripts implemented by a time-series generation module (e.g., time-series data injection and snapshot generation module 260) and executed by one or more processors of one or more computer systems of a backend processing system (e.g., backend processing system 154 or 254) of a product support system (e.g., product support system 150).

At decision block 410, it is determined whether a trigger event has occurred. If so, processing continues with block 420; otherwise, processing loops back to decision block 410. In one embodiment, the trigger event represents the periodic expiration of a timer, which may be active (e.g., continually run and reset) during particular days (e.g., business days) of the year or every day. The timer may be set for a predetermined or configurable period of time (e.g., X minutes, Y hours, etc.).

At block 420, support case data is ingested from multiple data sources. In one embodiment, the support case data is read from indirect data sources (e.g., data warehouses 240) that are periodically synchronized with direct data sources (e.g., data sources 230). In one embodiment, daily snapshots are created on a periodic basis (e.g., hourly) to determine counts of active support cases by product/service, aging support cases (e.g., those active support cases for which the customer issue has remained unresolved for 90 days) and not-updated active support cases (e.g., those active support cases for which comments have not been updated in 14 days). For example, various SQL queries may be run against the data sources in near real-time to select the desired subset of support case data.

At block 430, time-series data may be generated based on the current state of the support case data. For example, counts of active support cases, aging support cases, and not-updated active support cases may be calculated. Additionally or alternatively, target counts for aging support cases and/or not-updated support cases may be dynamically calculated based on one or more of a current number of active support cases for products that are actively shipping, a current number of active support cases for products that have been retired from the market (e.g., products at the end of the product lifecycle or designated as end-of-life (EOL) products), and a current number of active support cases for products with no codename identified. For example, the target count for aging support cases may be generated based on the floor of the sum of: (i) a predefined or configurable percentage (e.g., 2.5%) of all active cases for products that are actively shipping multiplied by the number of actively shipping products; (ii) a predefined or configurable percentage (e.g., 2%) of all active cases for products that are EOL or in samples; and (iii) a predefined or configurable percentage (e.g., 1%) of all active cases for products with no codename identified. Similarly, the target count for not-updated cases may be generated based on the floor of the sum of: (i) a predefined or configurable percentage (e.g., 1%) of all active cases for products that are actively shipping multiplied by the number of actively shipping products; (ii) a predefined or configurable percentage (e.g., 1%) of all active cases for products that are EOL or in samples; and (iii) a predefined or configurable percentage (e.g., 1%) of all active cases for products with no codename identified.

At block 440, the time-series data is persisted. For example, the time-series data generated at block 430 may be persisted along with a current timestamp to a SQL server (e.g., historical KPI database 270) that is accessible by both the backend processing system and a frontend processing system (e.g., correlation and visualization system 252). In this manner, the backend processing system facilitates access to historical versions of various metrics for the support case data, indicators, targets, and the like by the frontend processing system. Example pseudo code for the generation of daily snapshots of support cases is provided below in connection with Algorithm #1.

While in the context of various examples described herein, time-series data may be created at predetermined or configurable intervals for certain categories of support cases (e.g., active support cases, aging support cases, and not-updated active support cases), it is further contemplated that the time-series data may alternatively or additionally be created based on filters (by manager, owner, product, issue type, and/or the like) specified by a given support engineer, for example. In this manner, the product support system may be expanded to offer per-engineer objectives and key results (OKRs).

Algorithm #1: Example Generation of Daily Snapshots

For purposes of completeness, a non-limiting pseudo code example of a script for performing daily snapshot generation is presented below:

| 1. | Connect to Hadoop data lake( ) | |
|---|---|---|
| 2. | Run queries to calculate the following: | |
| | a. | The latest active case counts by |
| | | product/service codename |
| | b. | The latest count of aging cases by current |
| | | work week (WW) |
| | c. | The latest count of not updated cases by |
| | | current WW |
| 3. | Look up product case table (e.g., table including | |
| | a listing of the number of cases for each product | |
| | name) | |
| 4. | Calculate the latest targets for the current WW | |
| | based on the product case table (see, e.g., block | |
| | 430 of FIG. 4) | |
| 5. | Connect to SQL server( ) : | |
| 6. | | For the aging case table: |
| 7. | | If current WW already has a row in the |
| | | table: |
| 8. | | Update the row with new value for |
| | | count of aging cases |
| 9. | | Update the row with the new target |
| | | for the current WW |
| 10. | | Else: |
| 11. | | Add new row with current WW and |
| | | count of aging cases |
| 12. | | Update the row with the new target |
| | | for the current WW |
| 13. | | Commit the changes to the SQL table on |
| | | the server |

| | |
|---|---|
| 14. | Repeat the above for not updated case table |
| 15. | Close connection to SQL Server ( ) |
| 16. | Close connection to the Hadoop data lake( ) |
| 17. | End( ) |

At decision block 450, it is determined whether a snapshot trigger has occurred. If so, processing continues with block 460; otherwise, processing loops back to decision block 410. In one embodiment, the snapshot trigger represents the periodic expiration of a timer, which may be active (e.g., continually run and reset) during particular days (e.g., business days) of the year or every day. The timer may be set for a predetermined or configurable period of time (e.g., X hours, Y days, etc.).

At block 460, a snapshot of active support cases may be generated and persisted. In one embodiment, monthly snapshots of active support cases are created on a periodic basis (e.g., daily at a particular time) to determine a count of active support cases. For example, an SQL query may be run against the data sources to select from all support case data those support case records that remain active. The count of monthly active support cases may then be created or updated as the case may be within a monthly active case table on the SQL server. Example pseudo code for the generation of monthly snapshots is provided below in connection with Algorithm #2

Algorithm #2: Example Generation of Monthly Snapshots

For purposes of completeness, a non-limiting pseudo code example of a script for performing monthly snapshot generation is presented below:

| | |
|---|---|
| 1. | Connect to Hadoop data lake( ) |
| 2. | Run queries to calculate latest “monthly active |
| | case count” |
| 3. | Identify current month( ) |
| 4. | Connect to the monthly active case table on the |
| | SQL server |
| 5. | If current month already has a row in the table |
| 6. | Update that row with “monthly active case |
| | count” |
| 7. | Else: |
| 8. | Add new row to the table with “monthly |
| | active case count” Commit the changes to the |
| | SQL table on the server |
| 9. | Close connection to Hadoop data lake |
| 10. | Close connection to SQL server |
| 11. | End( ) |

In one embodiment, in addition to or instead of the monthly snapshots, quarterly snapshots of active support cases may be created on a periodic basis (e.g., daily at a particular time) to determine a count of active support cases. For example, an SQL query may be run against the data sources to select from all support case data those support case records that remain active. The count of quarterly active support cases may then be created or updated as the case may be within a quarterly active case table on the SQL server. Example pseudo code for the generation of quarterly snapshots of active support cases is provided below in connection with Algorithm #3.

Algorithm #3: Example Generation of Quarterly Snapshots

For purposes of completeness, a non-limiting pseudo code example of a script for performing quarterly snapshot generation is presented below:

| | |
|---|---|
| 1. | Connect to Hadoop data lake( ) |
| 2. | Run queries to calculate latest “quarterly active |
| | case count” |
| 3. | Identify current quarter( ) |
| 4. | Connect to the quarterly active case table on the |
| | SQL server |
| 5. | If current quarter already has a row in the table |
| 6. | Update that row with “quarterly active case |
| | count” |
| 7. | Else: |
| 8. | Add new row to the table with “quarterly |
| | active case count” |
| 9. | Commit the changes to the SQL table on the |
| | server |
| 10. | Close connection to Hadoop data lake |
| 11. | Close connection to SQL server |
| 12. | End( ) |

### Example Automated Alert Generation

FIG. 5 is a flow diagram illustrating operations for performing automated alert generation according to some embodiments. The processing described with reference to FIG. 5 may be performed by one or more scripts implemented by an alerting module (e.g., alerting module 280) and/or a notification system (e.g., notification system 256) and executed by one or more processors of one or more computer systems of a backend processing system (e.g., backend processing system 154 or 254) of a product support system (e.g., product support system 150).

At decision block 510, it is determined whether a trigger event has occurred. If so, processing continues with block 520; otherwise, processing loops back to decision block 510. In one embodiment, the trigger event represents the periodic expiration of a timer, which may be active (e.g., continually run and reset) during particular days (e.g., business days) of the year or every day. The timer may be set for a predetermined or configurable period of time (e.g., X days, Y weeks, etc.). In one embodiment, the trigger event occurs once per work week (e.g., Friday at 4:00 PM) to facilitate customer issue prioritization by support engineers during the current or subsequent work week.

At block 520, organizational information is loaded. For example, information indicative of the reporting chain within the product support team may be loaded to enable identification of a given support engineer's manager or direct report and/or those of the support engineers reporting to or managed by a given manager. The organizational information may include, among other things, the names and email addresses of members of the product support team.

At block 530, violating support cases are identified from those of the active support cases. For example, the alerting module may query data sources containing the support case records (e.g., directly via data sources 230 or indirectly via data warehouses 240) to identify active support cases meeting predefined or configurable violation criteria (e.g., active support cases for which the comments have not been updated for 14 days and/or active support cases that have remained unresolved for 90 days).

At block 540, non-violating support cases are identified from those of the active support cases as well as recently closed support cases and interested-party cases. For example, the alerting module may query data sources containing the support case records (e.g., directly via data sources 230 or indirectly via data warehouses 240) to identify active support cases meeting predefined or configurable violation criteria (e.g., active support cases for which the comments have been updated within 14 days and/or support cases that have been resolved within the last work week). Interested-party cases may represent support cases having similar issues.

At block 550, the support cases are grouped by owner. For example, the information returned as a result of the queries of blocks 530 and 540 may be sorted.

At block 560, an electronic communication (e.g., electronic communication 257) is composed for each support engineer regarding those of the violating support cases owned by the support engineer. In one embodiment, the electronic communication is composed by the alerting module in the form of an email message directed to the support engineer and includes the manager of the support engineer in the carbon copy field of the email message. The alerting module may make use of the notification system to deliver the electronic communication to the support engineer. The periodic alerts (e.g., once per work week emails) to the product support team may assist the support engineers in connection with prioritizing the support cases on which to focus their attention, thereby facilitating the prompt resolution or escalation of not-updated support cases and/or aged support cases.

At block 570, an electronic communication (e.g., electronic communication 257) is composed for each support engineer regarding those of the non-violating support cases owned by the support engineer and/or non-violating or recently closed cases for which they are identified as an interested party. In one embodiment, the electronic communication is composed by the alerting module in the form of an email message directed to the support engineer and includes the manager of the support engineer in the carbon copy field of the email message. The alerting module may make use of the notification system to deliver the electronic communication to the support engineer. By bringing the interested party support cases to the attention of the support engineers, the product support team may collaborate with each other on similar issues and/or leverage the findings of similar issues that may already have been resolved by other support engineers.

While in some examples, two electronic communications (e.g., a “violation email” and an “issues email” may be sent, it is to be appreciated the violations and issues may be communicated via the same communication (that is, the electronic communications of blocks 560 and 570 may be combined) or a single communication may be limited to either violations or issues (that is, only one of blocks 560 and 570 may be performed) depending upon the particular implementation.

Example pseudo code for the generation of weekly alerting communications regarding support cases is provided below in connection with Algorithm #4.

Algorithm #4: Example Generation of Alerting Communications

For purposes of completeness, a non-limiting pseudo code example of a script for performing generating and delivery of alerting emails is presented below:

| | |
|---|---|
| 1. | Load organizational structure (e.g., from Org |
| | Tree spreadsheet) |
| 2. | Identify violating cases i.e., have not been |
| | updated in 14 days. |
| 3. | Identify all non-violating active cases, recently |
| | closed cases and interested-party cases |
| 4. | Group identified cases by owner |
| 5. | Compose a violations-only email for each support |
| | case owner (e.g., the support engineer) |
| 6. | Include in that email all cases identified with |
| | violations |
| 7. | Use Organizational structure to identify & carbon |
| | copy the support case owner's manager |
| 8. | Send the “violation email” |
| 9. | Compose an issues email for each support engineer |
| 10. | Include in that email all support cases assigned |
| | to (owned by) the support engineer or support |
| | cases that the support engineer is identified as |
| | an interested party |
| 11. | Use Organizational structure to identify & carbon |
| | copy the support engineer's manager |
| 12. | Send the “issues email” |

### Example Generation of Dashboard Charts

FIG. 6 is a flow diagram illustrating operations for generation of dashboard charts according to some embodiments. The processing described with reference to FIG. 6 may be performed by one or more scripts implemented by a data correlation module (e.g., data correlation module 360) and with the assistance of a data visualization platform (e.g., data visualization platform 380) executed by one or more processors of one or more computer systems of a frontend processing system (e.g., correlation and visualization system 152 or 2524) of a product support system (e.g., product support system 150).

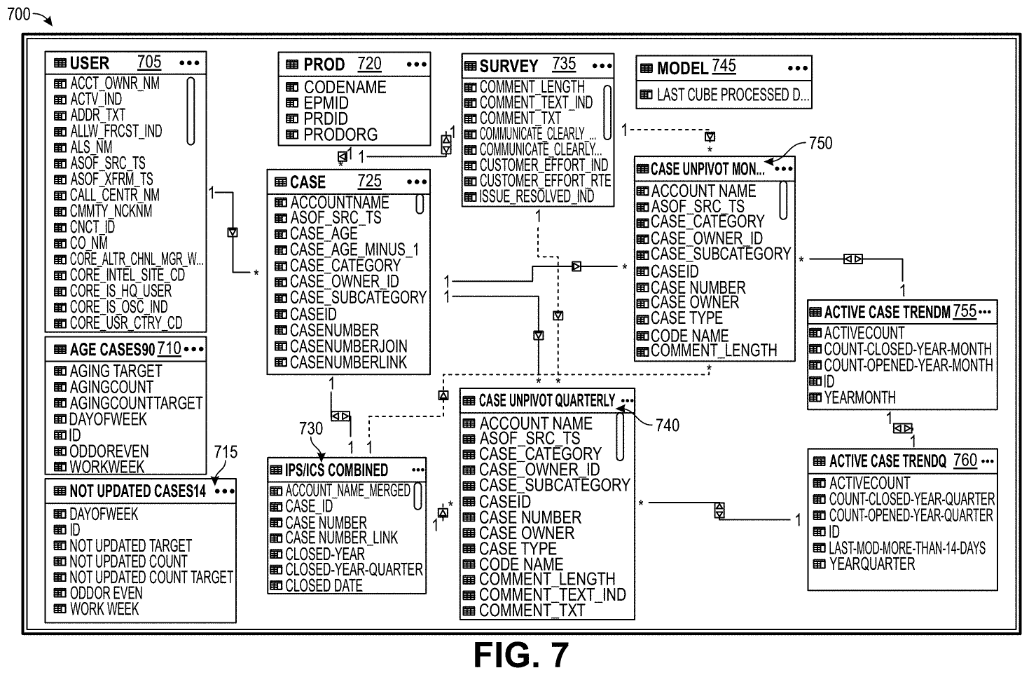

At block 610, product support case data and customer feedback data may be loaded from data warehouses (e.g., data warehouses 340) and a database containing historical metrics (e.g., historical KPI database 370). In one embodiment, customers may be prompted to provide feedback via a survey (e.g., an NPS survey) at some point during the product support case workflow (e.g., upon resolution of their particular issue or upon closure of their support case). In one embodiment, the data correlation module correlates the product support case data and customer feedback data retrieved from the data warehouses with time-series data extracted from the historical KPI database to facilitate graphical presentation of indicators, trends, and targets, for the support case data at various points in time (e.g., for a given quarter, month, day, and/or hour). For example, data from multiple databases or tables may be correlated based on a support case ID and/or another attribute. Depending upon the particular implementation, a number of other data sources may part of the data model employed by the product support system and may be correlated with the case table as described further below with reference to FIG. 7.

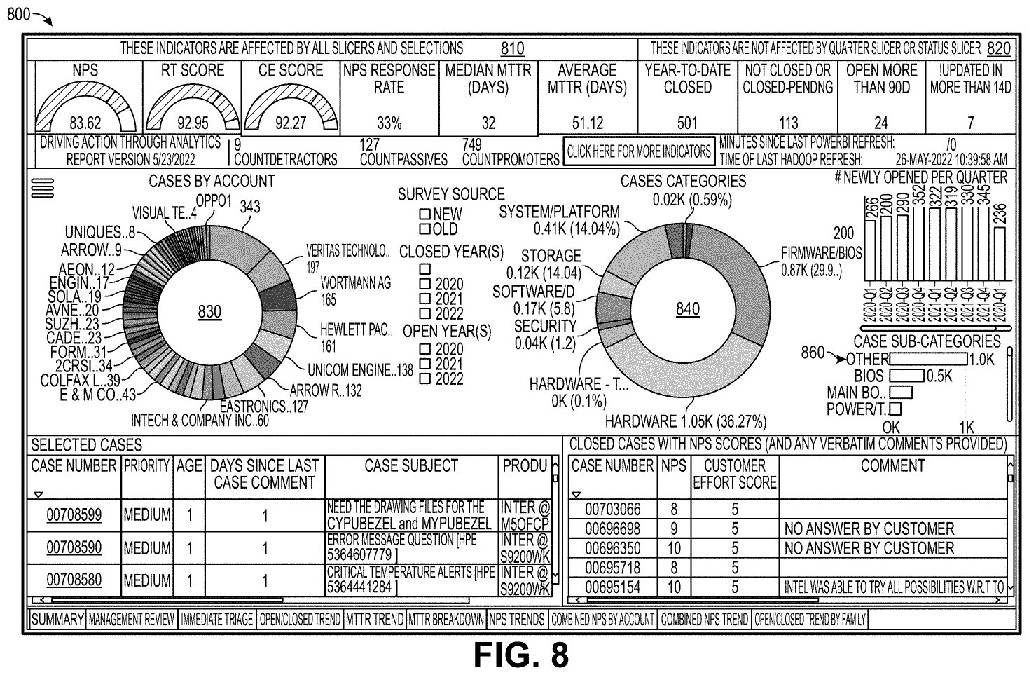

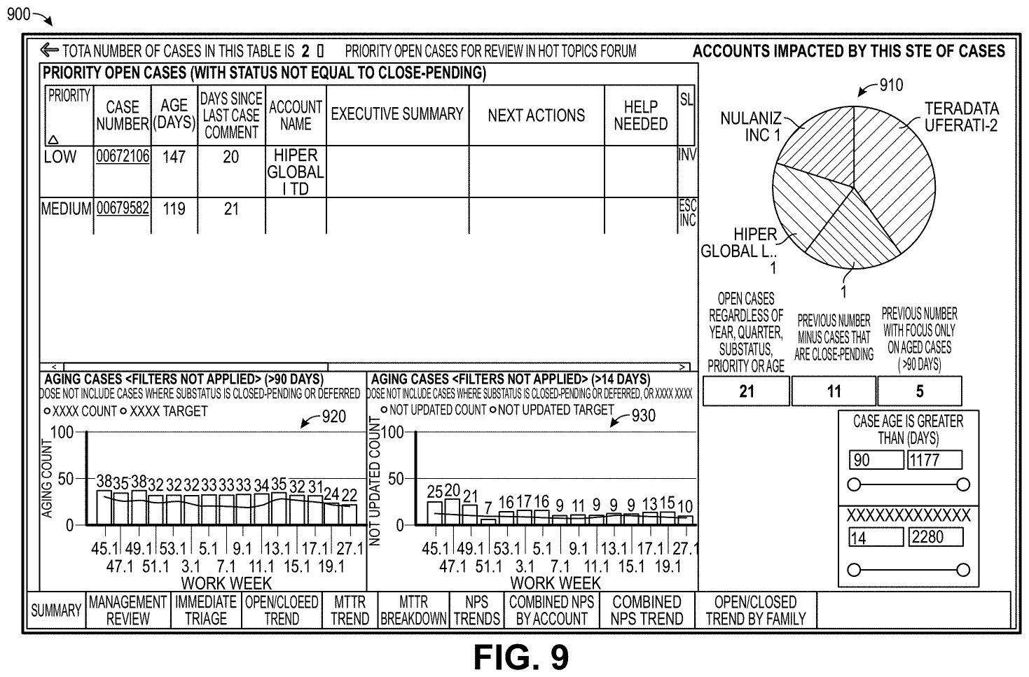

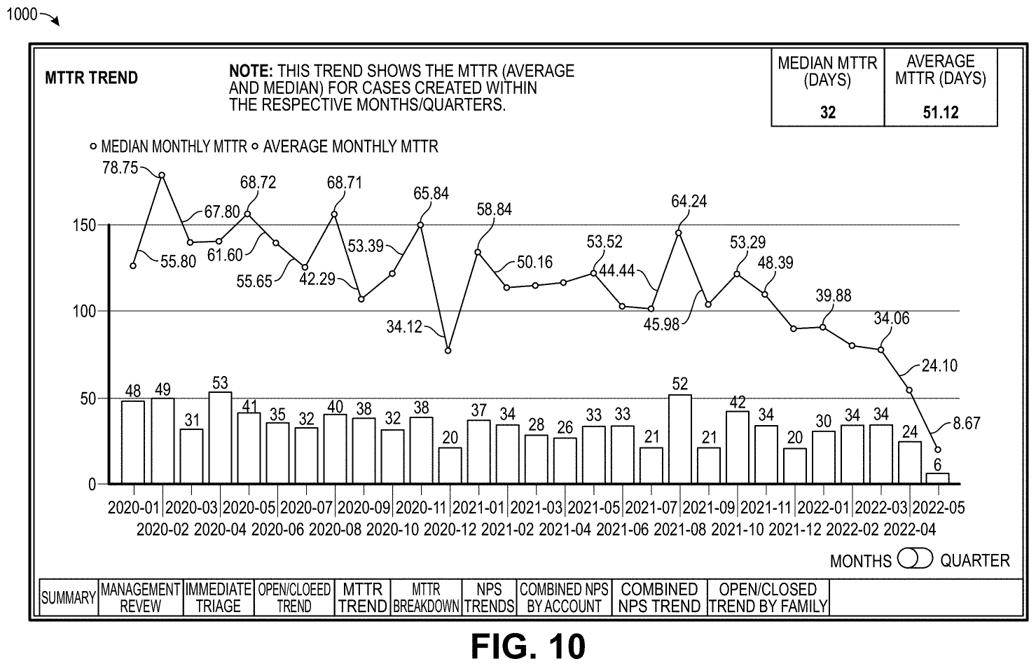

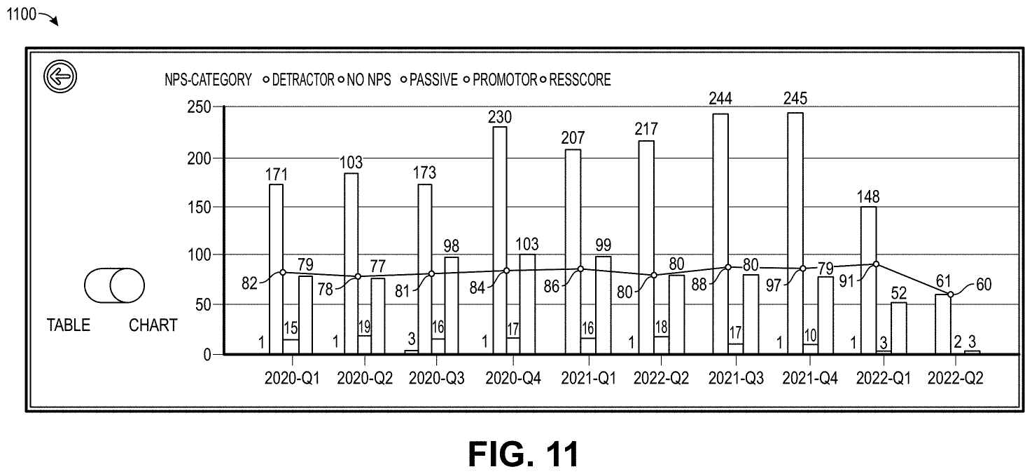

At block 620, a predetermined or configurable set of available charts are built. The charts may be presented within a UI/UX of the product support system in a variety of forms. For example, the data correlation module may cause the data visualization platform to generate and present on a display of a workstation of a member of the product support team, among other visualizations, (i) a visualization of support cases, key performance indicators (KPIs) (an example of which is illustrated by FIG. 8), and customer feedback; and (ii) a visualization that may be used for day-to-day triaging of support cases (an example of which is illustrated by FIG. 9); (iii) trend charts for various metrics (examples of which are illustrated by FIGS. 10 and 11).

At block 630, various metrics (e.g., KPIs) may be calculated based on the support data and filtered based on default settings or current user settings of a particular member of the support team. For example, when certain metrics are to be presented to a particular member of the support team, default settings (e.g., indicative of a particular timeframe or granularity) may be applied unless overridden by corresponding setting saved by the particular member of the support team. Non-limiting examples of such metrics include indicators (e.g., NPS, RT, CE, NTTR), trends (e.g., counts of not-updated cases and/or aged cases for various timeframes), and targets (e.g., predefined, configurable, and/or dynamically calculated maximum thresholds for counts of not-updated cases and/or aged cases).

In one embodiment, members of the support team may save particular views of the data that suit their particular needs or in which they are otherwise interested. For example, a manager of a team of product support engineers may establish settings to view the quarterly or monthly trend of the MTTR of closed cases or a trend of aging and/or not-updated case counts against corresponding targets for their team. In contrast, a product support engineer may be more interested in being presented with data and/or metrics for active support cases owned by them or for which they are an interested party.

At block 640, the charts are filtered based on default settings or current user settings of the particular member of the support team. For example, when a dashboard is to be created for presentation to the particular member of the support team, default settings (e.g., filters indicative of a timeframe or granularity of a particular chart and/or filters indicative of types, categories or other subsets of support cases) may be applied unless overridden by corresponding user setting saved by the particular member of the support team.

As above, in one embodiment, members of the support team may save particular views of the data that suit their particular needs or in which they are otherwise interested. For example, one manager of a team of product support engineers may establish settings to be initially presented with high-level charts across accounts and across case categories as illustrated by FIG. 8., whereas another manager may establish settings to be initially presented with charts and/or graphs showing long-term trends for a particular KPI as illustrated by FIGS. 10 and 11.

Thereafter, at block 650, as the user is interacting with the charts, the metrics and charts may be updated as appropriate based on user selections, for example, indicative of newly selected filters. For example, the default settings or current user settings may be overridden by a drill-down (zoom in) or drill-up (zoom out) UI operation or a UI operation performed by the particular member of the support team that otherwise changes the data slice(s) (e.g., in terms of type of issue, category of support case, timeframe, manager, owner, customer, etc.) to be visualized while interacting with the particular chart.

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

Algorithm #5: Example Generation of Dashboard Charts

For purposes of completeness, a non-limiting pseudo code example of a script for performing dashboard chart generation is presented below:

| | |
|---|---|
| 1. | Load_tables for L1 and L2 support cases from the |
| | Hadoop data lake |
| 2. | Load_tables for L3 support cases from the Hadoop |
| | data lake |
| 3. | Load_tables from the SQL server |
| 4. | Build charts for historical aging cases (source = |
| | SQL server) |
| 5. | Build charts for historical not updated cases |
| | (source = SQL server) |
| 6. | Build charts for monthly active cases (source = |
| | SQL server) |
| 7. | Build charts for quarterly active cases (source = |
| | SQL server) |
| 8. | Build charts for L1 and L2 support case table |
| | (source = Hadoop) |
| 9. | Build a combined chart with L1, L2, and L3 |
| | support cases (source = Hadoop) |
| 10. | Calculate KPIs (NPS, MTTR, etc.) |
| 11. | Filter all charts as per defaults, current user |
| | settings and user selections |
| 12. | Update KPIs based on filters |

### Example Data Model

FIG. 7 is an entity relationship diagram illustrating an example data model 700 according to some embodiments. In the context of the present example, the data model includes:
A user table 705 containing information about the user that filed the support case.
An aged cases table 710 representing a historical data table capturing the number of aged cases and the target for a given time period (e.g., a work week).
A not-updated cases table 715 representing a historical data table capturing the number of not-updated cases and the target for a given timeframe (e.g., a work week).
A product table 720 containing information about the product that the support case is about.
A case table 725 containing information about each support case, including, among other things, the author (or owner), the case type, the description.
A combined support data table 730 that enables combining support cases from multiple sources (e.g., the L1 and L2 support data 132 and the L3 support data 134) pertaining to the same customer/user.
A survey table 735 containing survey responses (e.g., responses to a customer/user feedback survey, such as an NPS survey), scores and comments of customers/users whose cases were closed.
A case unpivot quarterly table 740 representing a connector table use to enable filtering in a quarterly view presented via a UI/UX of the product support system (e.g., product support system 150).
A model table 745 indicating the state of the data, for example, when a Hadoop cube (e.g., of data lake 142 or 144) was last refreshed.
A case unpivot monthly table 750 representing a connector table use to enable filtering in a monthly view presented via the UI/UX.
An active case trend monthly table 755 containing historical closed, opened and active case counts for each month.
An active case trend quarterly table 760 containing historical closed, opened and active case counts for each quarter.

In this example, everything generally revolves around the case table 730, which tracks the issues that customers/users have with product/services (e.g., a server product). Several of the other tables are correlated to the case table 725 (e.g., via a unique case ID associated with the product support cases) as shown by the connections between the tables indicating either a one-to-one relationship or a one-to-many relationship. For example, each support case is associated with a single user, a single product, and a single survey; however, a user may have multiple cases and multiple cases may be related to the same product.

### Example Screen Shots

FIG. 8 is a screen shot illustrating an example visualization 800 of support cases, key performance indicators (KPIs), and customer feedback to facilitate consumption and interaction by product support management personnel according to some embodiments. In the context of the present example, some subset of indicators 810 (e.g., NPS, RT score, CE score, NPS response rate, median MTTR, and average MTTR) may be dynamically updated and represented in real-time based on data slices and/or user selections, when another subset of indicators 820 (e.g., the number of year-to-date closed cases, the number of not closed or closed-pending cases, the number of aged support cases, and the number of not-updated support cases) may be unaffected by data slicing. The screen shot 800 also includes a pie chart 830 of cases by customer account, a pie chart 840 by case categories, a bar chart 850 of newly opened support cases by quarter, and a bar chart 860 of case sub-categories. In one embodiment, the visualization 800 is interactive. For example, the indicators 810, the pie chart 830, the pie chart 840, the bar chart 850, and the bar chart 860 may be dynamically regenerated and redisplayed in near real-time responsive filtering (e.g., by manager, owner, customer, product, issue type, and the like) and/or slicing (e.g., by timeframe, such as day, week, month, quarter, year, etc.) selected by the product support team member.

FIG. 9 is a screen shot illustrating an example visualization 900 that may be used for day-to-day triaging of support cases according to some embodiments. In the context of the present example, a pie chart 910 may show the customer accounts impacted by a particular set of support cases (e.g., based on the currently selected filtering criteria), a combined bar chart and line graph 920 showing the trend of aging support case counts (the bars in this example) as compared to the corresponding trend of the target count for aging support cases (the line in this example) for a particular timeframe (e.g., the current work week), and a combined bar chart and line graph 930 showing the trend of not-updated support case counts (the bars in this example) as compared to the corresponding trend of the target count for not-updated support cases (the line in this example) for a particular timeframe (e.g., the current work week). As above, the various charts may be interactive and may be dynamically regenerated based on an updated user selections with respect to one or more of granularity, timeframe, or filters.

FIG. 10 is a screen shot illustrating an example MTTR trend chart 1000 according to some embodiments. In the context of the present example, the MTTR trend chart 1000 shows the MTTR (average and median via bars and line, respectively) for support cases created within the respective months/quarters.

FIG. 11 is a screen shot illustrating an example NPS trend chart 1100 according to some embodiments. In the context of the present example, the NPS trend chart 1100 (in the form of a combined bar chart and line graph) shows results of NPS survey responses in terms of the number detractors, the number of “no responses,” the number of passive, and the number of promotors via respective bars for a given quarter and the corresponding NPS score via the line.

### Example Computer System

FIG. 12 is an example of a computer system 1200 with which some embodiments may be utilized. Notably, components of computer system 1200 described herein are meant only to exemplify various possibilities. In no way should example computer system 1200 limit the scope of the present disclosure. In the context of the present example, computer system 1200 includes a bus 1202 or other communication mechanism for communicating information, and a processing resource (e.g., one or more hardware processors 1204) coupled with bus 1202 for processing information. The processing resource may be, for example, one or more general-purpose microprocessors or a system on a chip (SoC) integrated circuit.

Computer system 1200 also includes a main memory 1206, such as a random-access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, e.g., a magnetic disk, optical disk or flash disk (made of flash memory chips), is provided and coupled to bus 1202 for storing information and instructions.

Computer system 1200 may be coupled via bus 1202 to a display 1212, e.g., a cathode ray tube (CRT), Liquid Crystal Display (LCD), Organic Light-Emitting Diode Display (OLED), Digital Light Processing Display (DLP) or the like, for displaying information to a computer user. An input device 1214, including alphanumeric and other keys, is coupled to bus 1202 for communicating information and command selections to processor 1204. Another type of user input device is cursor control 1216, such as a mouse, a trackball, a trackpad, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Removable storage media 1240 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1200 may implement the techniques described herein using customized hard-wired logic, one or more ASICs or FPGAs, firmware or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1210. Volatile media includes dynamic memory, such as main memory 1206. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes interface circuitry 1218 coupled to bus 1202. The interface circuitry 1218 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 1218 may couple the processing resource in communication with one or more discrete accelerators 1205 (e.g., one or more XPUs).

Interface 1218 may also provide a two-way data communication coupling to a network link 1220 that is connected to a local network 1222. For example, interface 1218 may be an integrated services digital network (ISDN) card, cable modem, satellite modem, or a modem to provide a data communication connection to a corresponding type of telephone line. As another example, interface 1218 may be a local area network (LAN) card to provide a data communication connection to a compatible LAN. Wireless links may also be implemented. In any such implementation, interface 1218 may send and receive electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218. The received code may be executed by processor 1204 as it is received, or stored in storage device 1210, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a non-transitory machine-readable medium storing instructions, which when executed by one or more computer systems of a product support system cause the one or more computer systems to: capture data relating to a plurality of support cases including one or more levels of support data from a plurality of data sources external to the product support system in accordance with a predefined or configurable schedule; and create and persist time-series data in near real-time based on periodic snapshots of the plurality of support cases including counts of active support cases, not-updated support cases, and aged support cases of the plurality of support cases to enable access to historical versions of a set of metrics for the data by or on behalf of one or more product support personnel.

Example 2 includes the subject matter of Example 1, wherein the not-updated support cases represent those of the active support cases for which comments had not been updated for a predefined or configurable timeframe as of a particular date and wherein the aged support cases represent those of the active support cases that remained unresolved for a predefined or configurable timeframe as of the particular date.

Example 3 includes the subject matter of Examples 1-2, wherein the historical versions of the set of metrics include a dynamically calculated target for a count of the non-updated support cases calculated during creation of the time-series data based on a number of active support cases for products that are actively shipping and a number of active support cases for products that have been retired.

Example 4 includes the subject matter of Examples 1-3, wherein the historical versions of the set of metrics include a dynamically calculated target for a count of the aged support cases calculated during creation of the time-series data based on a number of active support cases for products that are actively shipping and a number of active support cases for products that have been retired.

Example 5 includes the subject matter of Examples 1-4, wherein the instructions further cause the one or more computer systems to on a periodic basis, for each support engineer of a plurality of support engineers: identify the not-updated support cases for which the support engineer is responsible; and provide the support engineer with an electronic communication including information regarding the identified non-updated support cases to facilitate prioritization by the support engineer of a workload of the support engineer.

Example 6 includes the subject matter of Examples 1-5, wherein the plurality of data stores comprise a plurality of Hadoop data lakes and wherein the method further comprises periodically synchronizing the plurality of Hadoop data lakes with a plurality of third-party data sources fewer than five times per day to avoid impacting mission critical tasks that make use of the plurality of third-party data sources.

Example 7 includes the subject matter of Examples 1-6, wherein the instructions further cause the one or more computer systems to: calculate a plurality of key performance indicators (KPIs) and trends for the KPIs based on the one or more data sources and the persisted enriched data and the snapshots; and cause to be presented to the one or more product support personnel via an interactive dashboard of a user interface graphical representations of the KPIs and trends.

Example 8 includes the subject matter of Examples 1-7, wherein the KPIs include one or more of a Net Promotor Score (NPS), Reasonable Time (RT), Customer Effort (CE), Time-to-Response (TTR), and Mean Time To Resolution (MTTR).

Some embodiments pertain to Example 9 that includes a method comprising: capturing, by one or more computer systems of a product support system, data relating to a plurality of support cases including one or more levels of information technology (IT) support data from a plurality of data sources in accordance with a predefined or configurable schedule; and enabling, by the one or more computer systems, access to historical versions of a set of metrics for the data by or on behalf of one or more product support personnel by creating and persisting time-series in near real-time data based on periodic snapshots of the plurality of support cases including counts of the plurality of support cases associated with one or more categories.

Example 10 includes the subject matter of Example 9, wherein the one or more categories include active support cases of the plurality of support cases, not-updated support cases of the active support cases, and aged support cases of the active support cases.

Example 11 includes the subject matter of Examples 9-10, wherein the not-updated support cases represent those of the active support cases for which comments had not been updated for a predefined or configurable timeframe as of a particular date.

Example 12 includes the subject matter of Example 9-11, wherein the aged support cases represent those of the active support cases that remained unresolved for a predefined or configurable timeframe as of a particular date.

Example 13 includes the subject matter of Examples 9-12, wherein the historical versions of the set of metrics include a count of the active support cases, a count of the not-updated support cases, and a count of the aged support cases.

Example 14 includes the subject matter of Examples 9-13, wherein the historical versions of the set of metrics further include a dynamically calculated target for the count of the non-updated support cases.

Example 15 includes the subject matter of Examples 9-14, wherein the historical versions of the set of metrics further include a dynamically calculated target for the count of the aged support cases.

Example 16 includes the subject matter of Examples 9-15, wherein the plurality of data stores comprise a plurality of data lakes and wherein the method further comprises periodically synchronizing the plurality of data lakes with a plurality of third-party data sources fewer than five times per day to avoid impacting mission critical tasks that make use of the plurality of third-party data sources.

Example 17 includes the subject matter of Examples 9-16, further comprising on a periodic basis, for each support engineer of a plurality of support engineers: identifying the not-updated support cases for which the support engineer is responsible; and facilitating prioritization by the support engineer of a workload of the support engineer by providing the support engineer with an electronic communication including information regarding the identified non-updated support cases.

Example 18 includes the subject matter of Examples 9-17, further comprising: calculating, by the one or more computer systems, a plurality of key performance indicators (KPIs), trends for the KPIs, and thresholds for the KPIs based on the one or more data sources and the persisted enriched data and the snapshots; and causing to be presented, by the one or more computer systems to the one or more product support personnel via an interactive dashboard of a user interface, graphical representations of the trends and thresholds.

Example 19 includes the subject matter of Examples 9-18, wherein the KPIs include one or more of a Net Promotor Score (NPS), Reasonable Time (RT), Customer Effort (CE), Time-to-Response (TTR), and Mean Time To Resolution (MTTR).

Some embodiments pertain to Example 20 that includes a product support system comprising: one or more computer systems; and instructions that when executed by one or more computer systems cause the one or more computer systems to: capture data relating to a plurality of support cases including one or more levels of support data from a plurality of data sources external to the product support system in accordance with a predefined or configurable schedule; and create and persist time-series data in near real-time based on periodic snapshots of the plurality of support cases including counts of active support cases, not-updated support cases, and aged support cases of the plurality of support cases to enable access to historical versions of a set of metrics for the data by or on behalf of one or more product support personnel.

Some embodiments pertain to Example 21 that includes a product support system comprising: a means for capturing data relating to a plurality of support cases including one or more levels of information technology (IT) support data from a plurality of data sources in accordance with a predefined or configurable schedule; and a means for enabling access to historical versions of a set of metrics for the data by or on behalf of one or more product support personnel by creating and persisting time-series in near real-time data based on periodic snapshots of the plurality of support cases including counts of the plurality of support cases associated with one or more categories.

Some embodiments pertain to Example 22 that includes an apparatus that implements or performs a method of any of Examples 9-19.

Example 23 includes at least one machine-readable medium comprising a plurality of instructions, when executed on a computing device, implement or perform a method or realize an apparatus as described in any preceding Example.

Example 24 includes an apparatus comprising means for performing a method as claimed in any of Examples 9-19.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by one or more computer systems of a product support system cause the one or more computer systems to:
capture data relating to a plurality of support cases including one or more levels of support data from a plurality of data sources external to the product support system in accordance with a predefined or configurable schedule; and
create and persist time-series data in near real-time based on periodic snapshots of the plurality of support cases including counts of active support cases, not-updated support cases, and aged support cases of the plurality of support cases to enable access to historical versions of a set of metrics for the data by or on behalf of one or more product support personnel.

2. The non-transitory machine-readable medium of claim 1, wherein the not-updated support cases represent those of the active support cases for which comments had not been updated for a predefined or configurable timeframe as of a particular date and wherein the aged support cases represent those of the active support cases that remained unresolved for a predefined or configurable timeframe as of the particular date.

3. The non-transitory machine-readable medium of claim 2, wherein the historical versions of the set of metrics include a dynamically calculated target for a count of the non-updated support cases calculated during creation of the time-series data based on a number of active support cases for products that are actively shipping and a number of active support cases for products that have been retired.

4. The non-transitory machine-readable medium of claim 2, wherein the historical versions of the set of metrics include a dynamically calculated target for a count of the aged support cases calculated during creation of the time-series data based on a number of active support cases for products that are actively shipping and a number of active support cases for products that have been retired.

5. The non-transitory machine-readable medium of claim 1, wherein the instructions further cause the one or more computer systems to on a periodic basis, for each support engineer of a plurality of support engineers:
identify the not-updated support cases for which the support engineer is responsible; and
provide the support engineer with an electronic communication including information regarding the identified non-updated support cases to facilitate prioritization by the support engineer of a workload of the support engineer.

6. The non-transitory machine-readable medium of claim 1, wherein the plurality of data stores comprise a plurality of Hadoop data lakes and wherein the method further comprises periodically synchronizing the plurality of Hadoop data lakes with a plurality of third-party data sources fewer than five times per day to avoid impacting mission critical tasks that make use of the plurality of third-party data sources.

7. The non-transitory machine-readable medium of claim 1, wherein the instructions further cause the one or more computer systems to:
calculate a plurality of key performance indicators (KPIs) and trends for the KPIs based on the one or more data sources and the persisted enriched data and the snapshots; and
cause to be presented to the one or more product support personnel via an interactive dashboard of a user interface graphical representations of the KPIs and trends.

8. The non-transitory machine-readable medium of claim 7, wherein the KPIs include one or more of a Net Promotor Score (NPS), Reasonable Time (RT), Customer Effort (CE), Time-to-Response (TTR), and Mean Time To Resolution (MTTR).

9. A method comprising:
capturing, by one or more computer systems of a product support system, data relating to a plurality of support cases including one or more levels of information technology (IT) support data from a plurality of data sources in accordance with a predefined or configurable schedule; and
enabling, by the one or more computer systems, access to historical versions of a set of metrics for the data by or on behalf of one or more product support personnel by creating and persisting time-series in near real-time data based on periodic snapshots of the plurality of support cases including counts of the plurality of support cases associated with one or more categories.

10. The method of claim 9, wherein the one or more categories include active support cases of the plurality of support cases, not-updated support cases of the active support cases, and aged support cases of the active support cases.

11. The method of claim 10, wherein the not-updated support cases represent those of the active support cases for which comments had not been updated for a predefined or configurable timeframe as of a particular date.

12. The method of claim 10, wherein the aged support cases represent those of the active support cases that remained unresolved for a predefined or configurable timeframe as of a particular date.

13. The method of claim 10, wherein the historical versions of the set of metrics include a count of the active support cases, a count of the not-updated support cases, and a count of the aged support cases.

14. The method of claim 13, wherein the historical versions of the set of metrics further include a dynamically calculated target for the count of the non-updated support cases.

15. The method of claim 13, wherein the historical versions of the set of metrics further include a dynamically calculated target for the count of the aged support cases.

16. The method of claim 9, wherein the plurality of data stores comprise a plurality of data lakes and wherein the method further comprises periodically synchronizing the plurality of data lakes with a plurality of third-party data sources fewer than five times per day to avoid impacting mission critical tasks that make use of the plurality of third-party data sources.

17. The method of claim 9, further comprising on a periodic basis, for each support engineer of a plurality of support engineers:
identifying the not-updated support cases for which the support engineer is responsible; and
facilitating prioritization by the support engineer of a workload of the support engineer by providing the support engineer with an electronic communication including information regarding the identified non-updated support cases.

18. The method of claim 9, further comprising:
calculating, by the one or more computer systems, a plurality of key performance indicators (KPIs), trends for the KPIs, and thresholds for the KPIs based on the one or more data sources and the persisted enriched data and the snapshots; and
causing to be presented, by the one or more computer systems to the one or more product support personnel via an interactive dashboard of a user interface, graphical representations of the trends and thresholds.

19. The method of claim 18, wherein the KPIs include one or more of a Net Promotor Score (NPS), Reasonable Time (RT), Customer Effort (CE), Time-to-Response (TTR), and Mean Time To Resolution (MTTR).

20. A product support system comprising:
one or more computer systems; and
instructions that when executed by one or more computer systems cause the one or more computer systems to:
capture data relating to a plurality of support cases including one or more levels of support data from a plurality of data sources external to the product support system in accordance with a predefined or configurable schedule; and
create and persist time-series data in near real-time based on periodic snapshots of the plurality of support cases including counts of active support cases, not-updated support cases, and aged support cases of the plurality of support cases to enable access to historical versions of a set of metrics for the data by or on behalf of one or more product support personnel.
